(19) United States
(12) Patent Application Publication
(10) Pub. No.: US 2004/0126522 A1
(43) Pub. Date: Jul. 1, 2004

(54) High temperature, high strength, colorable materials for device processing systems

(76) Inventors: Charles W. Extrand, Minneapolis, MN (US); Robert Bucha, Excelsior, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/683,474

(22) Filed: Oct. 9, 2003

Related U.S. Application Data
(60) Provisional application No. 60/417,150, filed on Oct. 9, 2002.

(51) Int. Cl. F16L 1/00

(52) U.S. Cl. 428/35.7

(57) ABSTRACT

Electrostatic-discharge safe devices for processing electronic components, e.g., matrix trays, chip trays, and wafer carriers are disclosed that are made from a mixture of a high temperature, high strength polymer and at least one metal oxide, and optionally with at least one pigment. The use of the metal oxides as conductive materials advantageously allows for light-colored electrostatic-discharge safe materials to be made. Such materials may be colored with pigments without compromise of material performance specifications.

### CROSS REFERENCE TO RELATED APPLICATIONS

This application claims priority to U.S. Provisional Patent Application Serial No. 60/417,150, filed Oct. 9, 2002, which is hereby incorporated by reference herein. The application is related to U.S. application Ser. No. 10/654,584, filed Sep. 3, 2003, entitled “High Temperature, High Strength, Colorable Materials for Use with Electronics Processing Applications”.

### FIELD

This application includes disclosures of colored articles for processing of computer and electronic components, e.g., articles such as wafer carriers, semiconductor trays, matrix trays, and disk processing cassettes.

### BACKGROUND

Complicated assembly lines are typically used to make electronic devices from small components. Thus carrier devices such as Read/Write head trays, disk process carriers, chip trays, and matrix trays are needed to hold the small components as part of the assembly process. The carrier devices are useful during the assembly process and also for storing and transporting the small components. Many carriers must prevent any electrostatic discharges (ESD) from harming the components. A carrier is made ESD-safe by making its surface that holds the component into a conductive surface. A conductive surface allows static electricity to dissipate so that a static charge can not build up on the component.

The components are typically small and dark-colored, and are therefore difficult to see if the carrier has a dark color. A dark color makes it difficult to verify that the components are present in the carrier and to remove them from the carrier, especially when machine vision is used.

Carrier devices are conventionally made from a material made by mixing a polymer with stainless steel or a carbon compound such as carbon black or carbon fiber. The stainless steel or carbon is sometimes referred to as a filler because it supplements the polymer's electrical properties by making the polymer into a conductive ESD safe material. The stainless steel is conductive, performs well at high temperatures, and creates a dark gray color. Stainless steel, moreover, is difficult to mix with a polymer to achieve a uniform distribution of stainless steel. Without a uniform distribution, the material is more prone to have small insulated spots that compromise the ESD-safe properties of the material. Further, the stainless steel has magnetic properties that could potentially damage some types of components. Moreover, materials made with stainless steel require high concentrations of pigments to make them lighter or to otherwise color them, so that other properties of the material may be compromised. The use of carbon fillers makes the carriers very dark or black since an efficacious amount of carbon imbues the plastic mixture with a dark color.

### SUMMARY

These problems are solved by making carriers that use small amounts of, or no, stainless steel and/or carbon fillers. Instead of such fillers, metal oxide fillers are used. The carriers are preferably made with materials made from a high temperature, high strength polymer and a metal oxide. Advantageously, the materials are colorable.

A preferred embodiment of the invention is a carrier, at least a portion of the carrier comprising an electrostatic discharge-safe surface for receiving a component, with the surface being made of a mixture of at least one high temperature, high strength polymer and at least one metal oxide. Examples of carriers are Read/Write head trays, disk process cassettes, chip trays, and matrix trays. The lightness of the color of the materials may be measured and assigned an L value in the CIE L*a*b* index (see discussion, below), e.g., more than about 40.

Another embodiment is an article for receiving electronic components that has a structure for contacting and supporting an electronic component, the structure having at least one electrostatic discharge-safe surface. The surface has a mixture of at least one high temperature, high strength polymer and at least one metal oxide, and has an L value of more than about 40, or about 55. The article may be, e.g., a disk processing cassette, a matrix tray, a chip tray, or a wafer carrier.

Another embodiment is a set of colored carriers for electronic component processing, the set comprising: at least two subsets of colored carriers wherein each colored carrier comprises an electrostatic discharge-safe surface. Each subset has a subset color distinct from the other subset colors. The surfaces are made with a high temperature, high strength polymer mixed with a metal oxide, and, optionally, a pigment. The carrier may be, e.g., a disk processing cassette, a matrix tray, a chip tray, or a wafer carrier.

Another embodiment is a method for processing electronic components, the method comprising placing an electronic component on an electrostatic discharge-safe surface of a colored carrier, with the surface comprising a mixture of at least one high temperature, high strength polymer, at least one metal oxide, and, optionally, at least one pigment. The carrier may be, e.g., a disk processing cassette, a matrix tray, a chip tray, or a wafer carrier.

Another embodiment is a method for producing an article for electronic processing, the method comprising molding a carrier having an electrostatic discharge-safe surface that comprises a high temperature, high strength polymer and a conductive filler, an L value of at least about 40, or about 55, and a resistivity in the range of 10₃ to 10₁₄ ohms per square, wherein the surface is flatter than an average of about 0.03 inches per inch. The carrier may be, e.g., a disk processing cassette, a matrix tray, a chip tray, or a wafer carrier.

Another embodiment is a carrier for receiving electronic components, the article comprising: a structure for contacting and supporting an electronic component, e.g., a wafer, the structure comprising at least one electrostatic discharge-safe surface that comprises a mixture of at least one high temperature, high strength polymer and at least one metal oxide, wherein the surface has an L value of more than about 40, or about 55, and wherein the carrier does not have a non metal oxide pigment. The carrier may be, e.g., a disk processing cassette, a matrix tray, a chip tray, or a wafer carrier.

### BRIEF DESCRIPTION OF THE FIGURES

FIG. 1 depicts the coordinate system for 1976 CIE L*a*b* Space and the L value for certain embodiments;

FIG. 2 depicts a multipocketed tray for receiving electrical components;

FIG. 3 depicts a cross-section of FIG. 2 in a view as indicated by line 3-3 in FIG. 2; and

FIG. 4 depicts a plurality of the trays of FIG. 2 in a stacked configuration.

FIG. 5 depicts a top view of a disk processing cassette;

FIG. 6 depicts a side view of the disk processing cassette of FIG. 5;

FIG. 7 depicts a chip tray in perspective view;

FIG. 8 depicts a top view of the chip tray of FIG. 7;

FIG. 9 depicts a section view along the line A-A of the chip tray of FIG. 8;

FIG. 10 depicts a side view of the chip tray of FIG. 8;

FIG. 11 depicts a perspective view of a chip tray;

### DETAILED DESCRIPTION OF THE PREFERRED EMBODIMENTS

A preferred embodiment of the invention is an ESD-safe carrier that is light in color, is made of a high temperature, high strength polymer, and contains a metal oxide filler. In some embodiments, the metal oxide filler may include a ceramic.

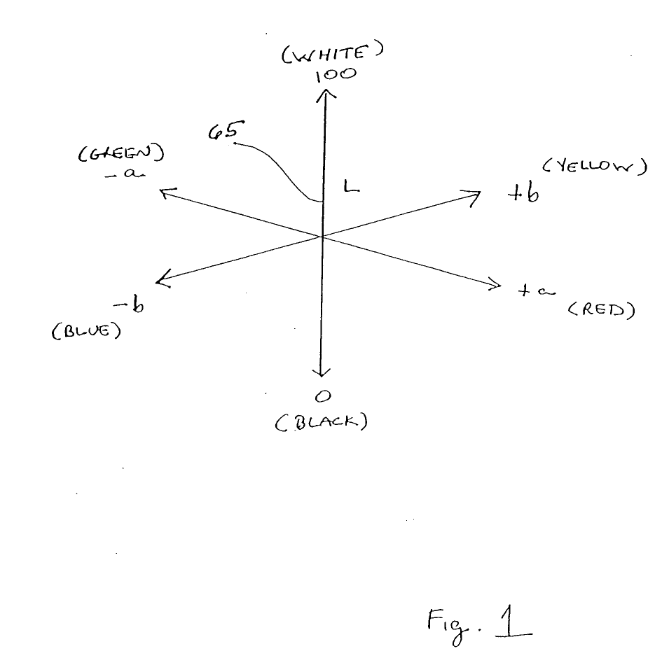

The lightness of the color of a material is objectively quantifiable using the Commission Internationale d'Eclairage L*a*b* color system (CIELab, see K. McLaren The Development of the CIE 1976 (L*a*b*) Uniform Colour-Space and Colour-Difference Formula, J. Society of Dyers and Colourists, 92:338-341 (1976) and G. A. Agoston, Color Theory and Its Application in Art and Design, Hedelberg 1979). As shown in FIG. 1, the 1976 CIE L*a*b* system assigns every color a position on a three-coordinate axis. L is the measure of lightness, and has a value that ranges from 0 (black) to 100 (white). “L” is used herein for the 1976 CIE L*a*b* system: elsewhere, L* may be used to refer to the same value described herein as “L”. The a* axis indicates the amount of red or green and the b* axis indicates the amount of yellow or blue. Thus a value of 0 for both “a*” and “b*” indicates a balanced gray. Since the CIELab system is device-independent, it is a popular choice for computer imaging applications. The CIELab values are measurable using standardized tests that are familiar to those skilled in these arts, for example, by using a reflectance meter. For example, reflectance meters are manufactured by Photovolt Instruments, Inc., Minneapolis, Minn., (Photovolt Model 577 and by Minolta Corporation, Ramsey, N.J., (model Minolta CM 2002). Thus L is an objective, quantifiable, and reproducible measure of the lightness of any color.

Referring to FIG. 1, certain embodiments of materials are set forth herein that provide for an L value that ranges from essentially 0 to about 100. For example, a very dark, near black, color may be achieved by mixing polymers with carbon black to achieve an L value of close to 0. And white pigments, e.g., titanium oxides, can be added to achieve a near-white color close to 100. An example of an electrostatic discharge-safe material suitable for use as a support for electronic component processing having a light color is a polyetheretherketone mixed with about 54% by weight antimony-doped tin oxide conductive material, which has an L value of 64.9, see “65” in FIG. 1, as measured using a reflectance spectrophotometer with output programmed for the CIELab system. Table A, below, shows the L value for various compositions, measured using the same technique. Samples containing polyetheretherketone were measured for consistency. Other polymers may be used, e.g., as described herein.

TABLE A
L-values for compositions having
conventional fillers or nonconventional fillers

| | Stainless | Carbon | | |
|---|---|---|---|---|
| | Steel, | Black, | Ceramic, | |
| Polymer | % w/w | % w/w | % w/w | L Value |
| Polyetheretherketone | 0 | 0 | antimony-doped | 65 |
| | | | tin oxide, 54% | |
| Polyetheretherketone | 0 | 18 | 0 | 32 |
| Polyetheretherketone | 25 | 0 | 0 | 37 |
| Polyetheretherketone | 30 | 0 | 0 | 38 |

In contrast to conventional processing methods in the relevant field of art, certain embodiments set forth herein provide for materials having a high L value while maintaining suitable mechanical and electrostatic discharge-safe conductive properties. Moreover, certain embodiments retain moldability characteristics such as flatness. An aspect of certain of these embodiments is the use of metal oxides or ceramics to achieve the electrostatic discharge-safe and coloration properties. Another aspect of certain of these embodiments is the use of high temperature, high strength polymers. Another aspect of certain of these embodiments is the use of isotropic flow particles. All L values in the continuum from about 0 to about 100 are contemplated. Certain embodiments achieve colorations having an L value of at least about 33, at least about 40, at least about 55, at least about 66, or at least about 80. Some embodiments have colorations that fall within an L value ranging from about 38 to about 100, from about 40 to about 99, and from about 40 to about 70. For example, a material with an L value of more than about 55 would mean that the material in question was closer to white on the CIELab scale than a material with an L value of less than about 55. As described herein, the conductive, polymeric, and conductive material concentrations are adjusted until a desired combination of mechanical, color, or conductive properties are achieved for the contemplated application. Such adjustment could readily be performed by a person of ordinary skill in these arts after reading this disclosure.

A high temperature, high strength polymer is preferably one having high resistance to heat and chemicals. The polymer is preferably resistant to the chemical solvent N-methyl pyrilidone, acetone, hexanone, and other aggressive polar solvents. A high temperature, high strength polymer has a glass transition temperature and/or melting point higher than about 150° C. Further, the high strength, high temperature polymer preferably has a stiffness of at least 2 GPa.

Examples of high temperature, high strength polymers are polyphenylene oxide, ionomer resin, nylon 6 resin, nylon 6,6 resin, aromatic polyamide resin, polycarbonate, polyacetal, polyphenylene sulfide (PPS), trimethylpentene resin (TMPR), polyetheretherketone (PEEK), polyetherketone (PEK), polysulfone (PSF), tetrafluoroethylene/perfluoroalkoxyethylene copolymer (PFA), polyethersulfone (PES; also referred to as polyarylsulfone (PASF)), high-temperature amorphous resin (HTA), polyetherimide (PEI), liquid crystal polymer (LCP), polyvinylidene fluoride (PVDF), ethylene/tetrafluoroethylene copolymer (ETFE), tetrafluoroethylene/hexafluoropropylene copolymer (FEP), tetrafluoroethylene/hexafluoropropylene/perfluoroalkoxyethylene terpolymer (EPE), and the like. Mixtures, blends, and copolymers that include the polymers described herein may also be used. Especially preferable are PEK, PEEK, PES, PEI, PSF, PASF, PFA, FEP, HTA, LCP and the like. Examples of high temperature, high strength polymers are also given in, for example, U.S. Pat. Nos. 5,240,753; 4,757,126; 4,816,556; 5,767,198, and patent applications EP 1 178 082 and PCT/US99/24295 (WO 00/34381) which are hereby incorporated herein by reference.

A metal oxide filler is a conductive material that includes metal oxide and can be added to a high temperature, high strength polymer to create an ESD safe material having a light color and sufficient mechanical properties for use as a carrier. The metal oxides are preferably mixed with ceramics or coated upon ceramics e.g., metal oxide doped ceramics. Such fillers typically have a light color that allows them to be used to make a light colored material. Since they have a light color, other coloring agents may be added to impart a particular color to the material. Further, ceramics are durable, and metal oxide/ceramic combination materials typically have electroconductive properties that are independent of humidity. A ceramic is a material consisting of compounds of a metal combined with a non-metallic element. Ceramics include metal oxides.

Examples of suitable metal oxides are exemplified by aluminum borate, zinc oxide, basic magnesium sulfate, magnesium oxide, potassium titanate, magnesium borate, titanium diboride, tin oxide, and calcium sulfate. This list of oxides is exemplary and not intended to limit the scope of the invention. Further examples of fillers are provided in, for example, U.S. Pat. Nos. 6,413,489; 6,329,058; 5,525,556; 5,599,511; 5,447,708; 6,413,489; 5,338,334; and 5,240,753, which are hereby incorporated herein by reference. In general, the metal oxides may be doped or coated with another metal as needed to impart or enhance conductivity.

A preferred filler is tin oxide, particularly antimony-doped tin oxide, for example, the family of products provided under the trade name Zelec® by Milliken Chemical Co. These products are small, roughly spherical-shaped, and light blue-gray to light green-gray in color. These colors allow for the creation of materials with a wide range of light colors, including white. Further, the antimony-doped tin oxide materials can be used to make transparent films and have the advantages of most ceramics, such as, non corrosiveness, resistance to acids, bases, oxidizers, high temperatures, and many solvents.

Another preferred class of fillers is whiskers, especially titanate whiskers, and more particularly potassium titanate and aluminum borate whiskers, which are described in, for example, U.S. Pat. Nos. 5,942,205 and 5,240,753, which are hereby incorporated herein by reference. The term whisker refers to a single crystal filament having a cross-sectional area of up to about 8×10⁻⁵ of a square inch and a length of about at least 10 times the average diameter. Whiskers are typically free of flaws and are therefore much stronger than polycrystals that have a similar composition. Thus certain whisker fillers can improve the strength of a composite material as well as impart other properties such as improved rigidity, abrasion resistance, and electrostatic dissipation. A preferred class of whiskers are provided under the trade name DENTALL by Otsuma Chemical Co., Japan; these are ceramic whiskers coated with a thin layer of tin oxide.

The sizes and shapes of the fillers are not limited and may be e.g., whiskers, spheres, particles, fibers, or other shapes. The sizes of the fillers are not limited, but small particles such as whiskers or comparably sized spheres, or very small sizes are preferable. Technologies for making very small particles, e.g., using nanotechnology, may be employed.

Suitable metal oxide fillers may be disposed in a variety of configurations. For example, an inert core particle may be coated with a metal oxide. The metal oxide coating is thus extended by the inert particle to result in a less expensive product. Alternatively, a hollow core may be used instead of an inert particle. Or, the size of the particles may be made smaller by omitting the core. Or, a ceramic may be doped with a metal oxide. Doped materials can be conductive while retaining the mechanical and coloring properties of the ceramic.

The metal oxide conductors should be disbursed in the material so that three-dimensional interconnecting networks of the conductors are formed. The networks serve as a circuit to drain static charges. The concentration of the metal oxide conductors is related to the ESD properties of the material. Very low concentrations of metal oxide conductors create a high surface resistivity. The resistivity drops slowly as the concentration of metal oxide conductors is increased until a “percolation threshold” is reached when the metal oxide conductors begin touching each other and further increases in the metal oxide conductor concentration cause rapid drops in resistivity. Eventually, a ceramic concentration is reached wherein further increases in the metal oxide conductor concentration fails to create substantial drops in resistivity because the metal oxide conductors have already formed an optimal number of networks. Typically, the addition of materials having less conductivity than the metal oxide conductors will result in increased surface resistivity. Thus, the addition of pigments can affect surface resistivity but compositions that have a desired resistivity can be made by adjusting the amounts of pigment and conductive filler.

There are numerous advantages to having a light-colored material for a carrier processing device, e.g., a chip tray, matrix tray, or disk processing cassette. One advantage is that the components in the processing device may be visualized. Machine vision systems are sensitive to color contrasts, so the ability to control the processing device color is an important advantage that helps to facilitate use of machine vision. Another advantage is that the processing devices are colorable. Thus the color may be optimized to make the components more easily visible. Or different types of processing devices may be made with different colors so that different models and applications of processing devices maybe easily recognized by a user. Or various types or sizes of components may be stored in processing devices of different colors so that shipping and use of the components is efficient.

Coloration may be accomplished by adding pigments known to those skilled in these arts. Examples of pigments include titanium dioxide, iron oxide, chromium oxide greens, iron blue, chrome green, aluminum sulfosilicate, cobalt aluminate, barium manganate, lead chromates, cadmium sulfides and selenides. Carbon black may be used if a black color is desired or if the carbon black is used in concentrations that do not create a dark or black color. Colors that may be achieved with the use of pigments spans the spectrum of visible light, including white.

Certain embodiments further incorporate pigments to achieve not only a desired L value, but also a particular color, e.g., red, green, blue, yellow, or combinations thereof. The pigments are added in a concentration suitable to achieve the desired color. The desired coloration may be accomplished by adding pigments known to those skilled in these arts, and mixing them with conductive materials and polymers as described herein to achieve a desired color, conductivity, and mechanical characteristics. Examples of pigments include titanium dioxide, iron oxide, chromium oxide greens, iron blue, chrome green, aluminum sulfosilicate, cobalt aluminate, barium manganate, lead chromates, cadmium sulfides and selenides. Carbon black may be used if a black color is desired or if the carbon black is used in concentrations that do not create an overly dark or black color. Colors that may be achieved with the use of pigments spans the spectrum of visible light, including white.

The filler(s) are preferably present in amounts sufficient to make the carrier have a surface resistivity in the range of about 10³ to 10¹⁴ ohms per square, a range that embues the surface with ESD-safe properties; more preferably the surface resistivity is in the range between about 10⁴ to less than about 10⁷ ohms per square. Optimal resistivity ranges, however, may depend on the particular application. Further, an acceptable chip tray surface resistivity is usually in the range of at least about 10⁷ to 10⁸ per square. In contrast, other components do not necessarily require the same resistivity. For example, an acceptable Read/Write head tray surface resistivity is usually in the range of about 10⁴ to less than about 10⁷ ohms per square. Since a conductive material must be added to a polymer to create an ESD safe material, a material with a resistivity of, e.g., 10⁸ ohms per square has less filler than a material with a resistivity of, e.g., 10⁴ ohms per square. Thus a Read/Write head try typically requires more conductive filler than a chip tray. Further, the filler is preferably evenly distributed through the material so as to avoid small insulated spots that compromise its ESD-safe properties. Further, the filler is preferably present in the concentration that avoids creating a black color in the material, and more preferably avoids creating a dark color in the material. The concentration of carbon black that is conventionally required to make an ESD safe material causes the material to be black.

Microchip trays are conventionally made with carbon black. The concentration of carbon black that is conventionally required to make an ESD safe material causes the material to be dark, and essentially black. Microchip trays, therefore, are not conventionally preferred for use as carriers for many components because the microchip trays are very dark colored due to the presence of the carbon filler. Further, the very dark color is a challenge to optimal performance of systems that use machine vision because the components are small and often dark-colored, and the microchip tray is dark.

An acceptable chip tray surface resistivity is usually in the range of at least about 10⁷ to 10⁸ per square. In contrast, an acceptable read/write head tray surface resistivity is usually in the range of about 10⁴ to less than about 10⁷ ohms per square. Since a conductive material must be added to a polymer to create an ESD safe material, and material with a resistivity of, e.g., 10⁸ ohms per square has more filler than a material with a resistivity of, e.g., 10⁴ ohms per square. Because of the uncertainties associated with increasing the amount of filler to high levels, approaches for making the ESD safe materials for computer chip trays can not be assumed to be transferable to read/right head trays. Moreover, materials used for use with computer chip processing, for example wafer carriers, must have very low levels of extractable metal ions, but this is not a major concern for Read/Write head tray materials. Therefore technologies and approaches for making microchip trays are not applicable to making Read/Write head trays.

For these reasons, scientists making Read/Write head trays have developed technologies that are different from technologies for making computer chip trays. Instead of using a carbon filler, Read/Write head trays are conventionally made with a metallic filler such as stainless steel. The stainless steel is conductive, performs well at high temperatures, and does not create a dark color in the material. Since the material is not dark, the read/write heads may be readily visualized.

The inventors have unexpectedly found the surprising result that high temperature, high-strength polymers may be mixed with more than about 40% ceramics by weight to achieve an ESD safe material without losing desirable processing properties such as moldability and flowability and without losing desirable mechanical properties such as compressive and tensile strength and appropriate rigidity. This result is surprising because, although polymers may be mixed with moderate amounts of non polymeric materials without losing the desirable properties of the polymer in the final product, the addition of a large amount of non polymeric materials, i.e. more than about 40% by weight, would be expected to result in a final product with properties that did not resemble those of the polymer. Ceramics treated with, or doped with, metal oxides are preferable for creating ESD safe materials. Large amounts of such ceramics, however, are typically required to achieve the desired conductivity in the materials. The preferred concentration range of ceramics is between about 40% and about 75%, a more preferred concentration range is between about 45% percent and about 70%, and a yet more preferable range is between about 50% and about 60%.

Moreover, it is surprising that the addition of more than about 40% by weight metal oxides and/or ceramics to a high strength, high temperature polymer can result in materials having surfaces that are flat, and even more surprisingly, flatter than surfaces achieved with stainless steel. In fact, however, the use of metal oxides with a high strength, high temperature polymer results in a Read/Write head tray that is more flat than trays made with stainless steel. The term smooth may sometimes used to refer to a lack of warp, but, for the sake of clarity, the term flat is adopted herein to denote a lack of warp. Warp is curvature that is sometimes undesirably introduced into a surface in a molding or other processing step. The term flat is thus not to be confounded with measures of roughness. Flatness is a desirable feature of carriers, including Read/Write head trays. One possible reason for the unexpected flatness is that the metal oxides used in the flat surfaces had isotropic flow shapes. An isotropic flow shape is a shape that resists becoming oriented in any particular direction as a result of forces created by a flowing fluid; in other words the flow characteristics of the particle are approximately the same in all directions. Thus a spherical particle has an isotropic flow shape because the particle does not become oriented in any particular direction when the particle is mixed in a flowing fluid. In contrast, a rod-shaped particle does not have an isotropic flow shape because it tends to align its longest axis in the direction parallel to the direction of flow.

A further advantage of using an isotropic flow shape is that such shapes promote consistent shrinkage in all directions. Molded articles typically shrink as they harden from the liquid to the solid state while in the mold. An anisotropic flow shape tends to produce inconsistent shrinkage because the anisotropic flow shape tends to preferentially align in one direction and to have different shrinkage properties in one direction. For example, an article molded from a material having a rod-shaped filler aligned in one predominant direction tends to shrink differentially along the axis parallel to the aligned direction compared to the axis transverse to the aligned direction. A consistent shrinkage is helpful when making articles that must be precisely designed to have only small variations in size.

Further, an isotropic flow shape promotes the creation of non-abrasive materials. An isotropic flow shape disposed on the surface of a material is smooth. In contrast, an anisotropic flow shape may project from a surface and present an abrasive point. For example, a spherical shape that is present on the surface presents a rounded non-abrasive surface. But a rod-shaped fiber that projects out of the surface is potentially abrasive to articles that contact the surface. So, for example, a Read/Write head placed on a material that contains isotropic flow shape components may thereby be exposed to a less abrasive material, as compared to a material having anisotropic components

It is also possible to reduce the specific gravity of materials that incorporate metal oxides and/or metal oxide ceramics. The specific gravity can be reduced by adding additional polymers or fillers to the material. One filler could be a low specific gravity filler, for example hollow glass spheres (3M Scotchlight™ glass bubbles). Alternatively, a lightweight polymer that forms materials having a low specific gravity could be blended into the material. Such polymers would preferably be chosen to segregate the metal oxide filler into a continuous phase so that the electrical properties of the final material would not be compromised. Examples of suitable lightweight polymers are styrene and amorphous polyolefin, for example, Zeonox™, Zeonex™, and Topaz™.

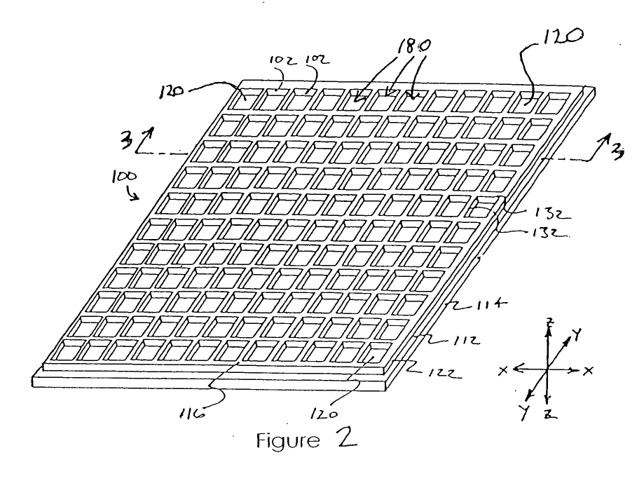

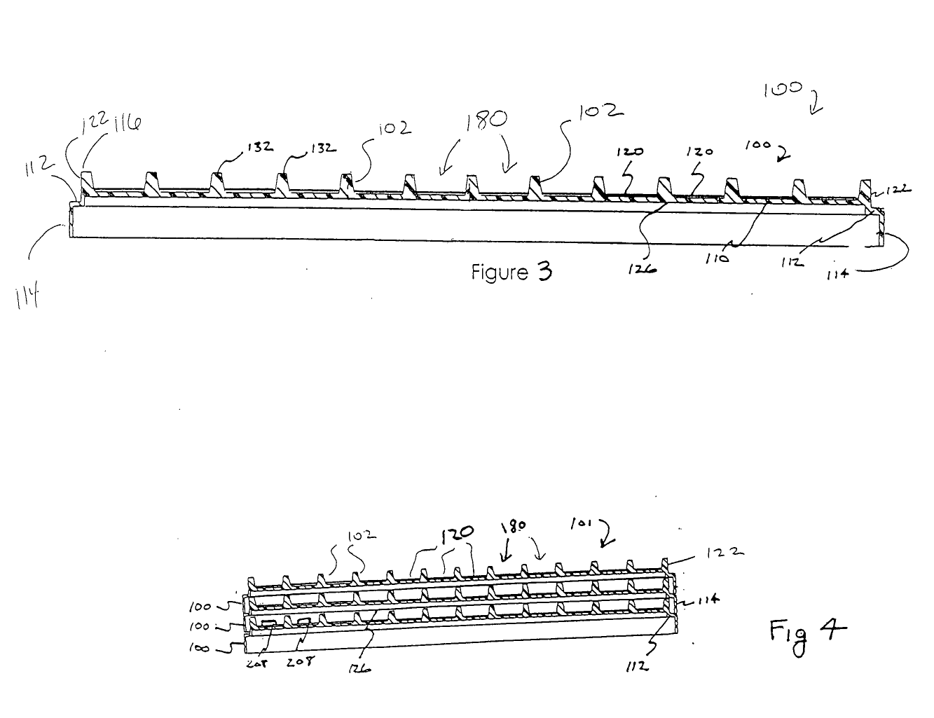

Many embodiments herein have been described in terms of Read/Write head trays because that is a preferred embodiment. However, these descriptions should also be understood as applying more generally to all types of trays that used in electronic processing. Trays are used, for example, for microchips, computer components, and audio component processes, see also U.S. Pat. No. 6,079,565 and U.S. patent Ser. No. 10/241,815, filed Sep. 11, 2002, which are hereby incorporated herein by reference. Electronic processing includes those manufacturing processes that involve assembling components for the electronics industry. Trays are useful for such processes because the components must be moved and/or stored in a fashion that is convenient and protects the components from contaminations and static discharges. A tray includes an electrostatic discharge-safe surface that receives and contacts an electronic component to thereby support it. Trays have a plurality of pockets, for example, as in FIGS. 2 and 3. The component is contained by the tray pocket, which may be, for example, an indentation, a space surrounded by walls, posts, or protrusions, a groove, or other structure that limits the component's mobility while on the tray so that the tray can successfully be moved without dislodging the component from the tray. For example, a pocket may be a space defined by grooves. Trays are preferably stackable (FIG. 4) and the stacks are preferably also stackable, e.g., on pallets, so as to facilitate processing.

Trays are used in the micro-electronic industry for storing, transporting, fabricating, and generally holding small components e.g., semi-conductor chips, ferrite heads, magnetic resonant read heads, thin film heads, bare dies, bump dies, substrates, optical devices, laser diodes, preforms, and miscellaneous mechanical articles such as springs and lenses.

To facilitate processing of chips on a large scale, specialized carriers called matrix trays have been developed. These trays are designed to hold a plurality of chips in individual processing cells or pockets arranged in a matrix or grid. The size of the matrix or grid can range from two to several hundred, depending upon the size of the chips to be processed. Examples of matrix trays are provided in, e.g., U.S. Pat. Nos. 5,794,783, 6,079,565, 6,105,749, 6,349,832, and 6,474,477.

Another type of tray is referred to as a chip tray, which is used for holding integrated semiconductor chips or related items, e.g., bare dies or processed wafers cut into individual components which are not encapsulated. Examples of chip trays are provided in, e.g., U.S. Pat. Nos. 5,375,710, 5,551,572, and 5,791,486.

Disk processing cassettes are used for processing disks, e.g., hard rigid memory disks. Examples of disk processing cassettes are provided in, e.g., U.S. Pat. No. 5,348,151, and 5,921,397.

Wafer carriers are used in the processing silicon wafers for the semiconductor industry, and are made using materials and designs to protect the wafers while they are being stored or processed. Examples of wafer carriers are shown in, e.g., United States Patent (or Publication) No. 20030146218, 20030132232, 20030132136, U.S. Pat. Nos. 6,248,177, 5,788,082, 5,788,082 and 5,749,469.

A surface may comprise a material by molding the surface from the material. Thus the materials in the surface are known if the material from which the surface is molded are known. Thus a surface may be assumed to resemble a material's bulk composition, even though it is appreciated that the very uppermost portions of a surface can have a composition that is distinct form the bulk of the material. Further, a surface may be determined to have an average flatness that is measurable in inches per inch. Conventional flatness measurements or L value colorimetric measurements may be used that provide an average for a significant portion of the surface. Such measurements can thus be distinguished from measurements that provide an average for a very small portion of the surface, e.g., atomic force microscopy.

Referring to FIGS. 2-4, tray 100 is depicted with a plurality of pockets 180. The pockets 180 have bottom surfaces 120 that form sides 102 that contain objects on the bottom surfaces 120. The top surface 132 of tray 100 is continuous and defines separations between pockets 180. Outer edge 116 of top surface 132 is continuous with and perpendicular to upper tray side 122. Tray side 122 is perpendicular to lip 112. Lip 112 is perpendicular to lower tray side 114. Referring to FIG. 4, trays 100 may be placed in a stacked configuration 101 without bottom tray surface 126 impinging on an electrical component, e.g., depicted by 208. Lip 112 acts as a stop for bottom tray surface 126.

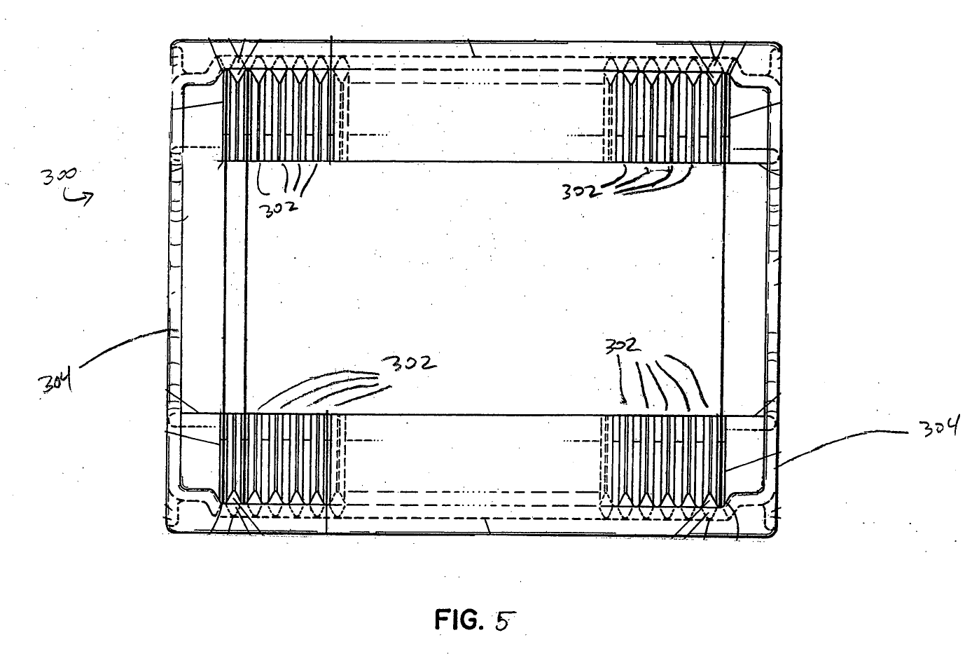

Referring to FIGS. 5 and 6, an embodiment of a disk processing cassette is depicted. Disk processing cassette 300 for processing of hard rigid memory disks includes a plurality of open supported opposing disk dividers 302 for supporting a plurality of disks in alignment by the dividers of the cassette. The dividers 302 are supported by two pairs of horizontal supports secured 304 to the ends. Each of the dividers 302, in upper and lower cross sections, are geometrically configured for maximum passage and ease of entry of fluids during processing.

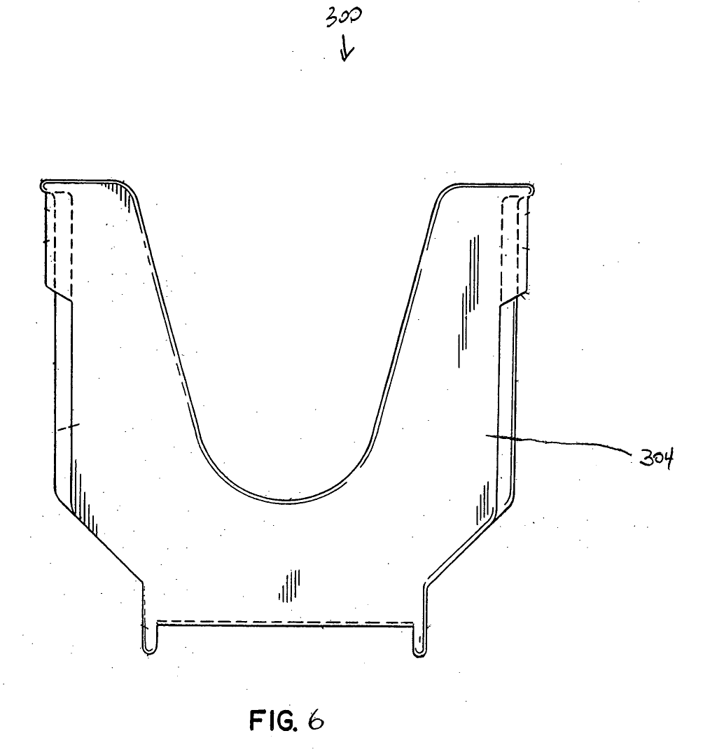

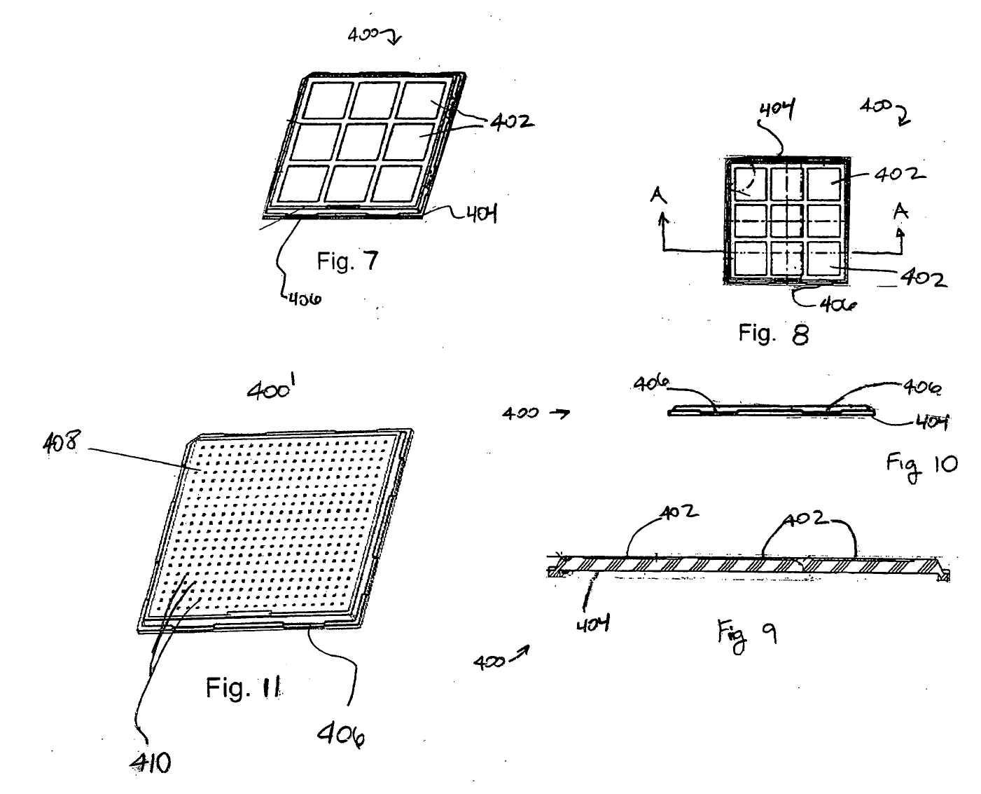

Referring to FIGS. 7-11, chip tray 400 has a plurality of pockets 402 in base 404. Base 404 has slots 406. Chip tray 400′ has a surface 408 with a plurality of pockets 410 therein. Pockets 404, 410 serve to receive chips during processing or for storage. The trays are stackable and configured to cooperate with automated processing equipment.

### EXAMPLE 1

Prototype Read/Write head trays were prepared by molding them from a mixture of metal oxide ceramics with PEEK, as indicated in Table 1. The molding process was essentially the same as the process used for PEEK loaded with stainless steel, although the molding temperature was adjusted slightly downwards. The results of these experiments showed that Zelec® ECP 1410T was a preferable metal oxide ceramic for use in making light colored Read/Write head trays. Moreover, the high temperature, high-strength polymer could be loaded with more than 40 percent of the filler without compromising the mechanical properties needed for the Read/Write head trays. Furthermore, the surfaces for holding the Read/Write heads were surprisingly found to be flat, with a flatness that exceeded the flatness obtained with stainless steel fillers. These experiments showed that suitable materials could be made for matrix trays, chip trays, wafer carriers, and disk processing cassettes.

TABLE 1
Mixtures of metal oxide particles with
high temperature, high-strength polymer.

| | Loading | | Surface Resistivity |
|---|---|---|---|
| Metal Oxide Filler | (wt. %) | Color | (ohms/square) |
| Ze1ec ® ECP 1410T | 40 | Light Gray | 10¹³ |
| Ze1ec ® ECP 1410T | 60 | Light Gray | 10⁵ |
| Ze1ec ® ECP 1410M | 40 | Dark Gray | 10⁵ |
| Zelec ® ECP 1410M | 60 | Did not work | — |
| Zelec ® ECP 1410XC | 40 | Did not work | — |
| Zelec ® ECP 1410XC | 60 | Did not work | — |

### EXAMPLE 2

Prototype Read/Write head trays were prepared by molding them from a mixture PEEK and a metal oxide ceramic, as indicated in Table 2. The molding process was essentially the same as the process used for PEEK loaded with stainless steel, although the molding temperature was adjusted slightly downwards. The results of these experiments showed that metal oxide ceramics could be used to make light colored Read/Write head trays that are ESD safe. Moreover, the high temperature, high-strength polymer could be loaded with more than 40 percent of the filler without compromising the mechanical properties needed for the Read/Write head trays. These experiments showed that suitable materials could be made for matrix trays, chip trays, wafer carriers, and disk processing cassettes.

TABLE 2
ESD properties of mixtures of metal oxide particles with
high temperature, high-strength polymer.

| Loading | Surface Resistivity | Static Dissipation |
|---|---|---|
| (percent %) | (ohms/square) | (seconds) |
| 40 | 10¹³ | 100 |
| 47 | 10¹³ | 120 |
| 52 | 10⁷ | 0.03 |
| 54 | 10⁵ | 0.03 |
| 60 | 10⁵ | 0.03 |
| 60 | 10⁵ | 0.03 |

### EXAMPLE 3

The properties of various compositions of PEEK mixed with metal oxide ceramics were compared, as indicated in Table 3, with a carbon fiber composition (18% wt.) and neat mixture of PEEK used as controls. Zelec® ECP 1410T (52%) was used as the metal oxide ceramic. The molding process was essentially the same as the process used for PEEK loaded with stainless steel, although the molding temperature was adjusted slightly downwards for most compositions. Shrinkage in the prototype head trays ranged from 0.008 to 0.013 in/in, an acceptable amount. Further, the prototypes were remarkably flat. The first prototype head tray model had a surface for receiving a Read/Write head having an average flatness of 0.004 +/−0.001 in/in with a maximum of 0.007 in/in. a second prototype head tray model had a surface for receiving a Read/Write head that had an average flatness of 0.013+/−0.010 in/in with a maximum of 0.017 in/in.

The results of these experiments showed that metal oxides could be used to make light colored ESD safe Read/Write head trays with more than 40 percent by weight of metal oxide filler without compromising the mechanical properties needed for the head trays. Further, these experiments showed that unexpectedly flat surfaces could be obtained using a high temperature, high strength polymer in combination with a metal oxide, such as a metal oxide ceramic. These experiments showed that suitable materials could be made for matrix trays, chip trays, wafer carriers, and disk processing cassettes.

TABLE 3
Properties of various compounds of metal oxides and PEEK.

| | | Carbon Fiber | Metal Oxide Ceramic |
|---|---|---|---|
| | Neat | (18%) | (52%) |
| Specific gravity | 1.3 | 1.4 | 2.1 |
| Melt temperature (° C.) | 349 | 344 | 344 |
| Modulus (GPa) | 3.9 | 11 | 6.5 |
| Break stress (MPa) | 80 | 110 | 90 |
| Break strain (%) | 50 | 1.8 | 1.8 |

### EXAMPLE 4

The resin purity properties of various compositions of PEEK mixed with metal oxide ceramics were compared, as indicated in Table 4, with a carbon fiber composition (18% wt.) and neat mixture of PEEK used as controls. Zelec® ECP 1410T (52% wt) was used as the metal oxide ceramic. The outgassing was measured by maintaining a sample for 30 minutes and a 10 Tenax tube at 100° C. and analyzing the released gasses using an automated thermal desorption unit-gas chromatograph/mass spectrograph. Metals were analyzed by placing plaques of the material in dilute nitric acid at 85° C. for one-hour and analyzing the extracted metals by ICP/MS inductively coupled plasma/mass spectrometer. Anions were analyzed by exposing the material to dilute water at 85 degrees C. for one-hour, followed by analyzing the water by ion chromatography. Table 5 shows the metals recovered. Table 6 shows the anions recovered.

The results of these experiments showed that the metal oxide ceramics had significantly more extractable metals than comparable materials formed using carbon fiber. The amount of extracted metals, however, was adequate for use in a Read/Write head tray. These experiments showed that suitable materials could be made for matrix trays, chip trays, wafer carriers, and disk processing cassettes.

TABLE 4
Resin purity for various high temperature, high-strength
compounds containing metal oxides.

| | | Carbon Fiber | Metal Oxide Ceramic |
|---|---|---|---|
| | Neat PEEK | (18%) | (52%) |
| Outgassing | 0.60 | 0.62 | 0.50 |
| (μg/gram) | | | |
| Metals | 6658 | 1057 | 2278 |
| (ng/g) | | | |
| Anions | 464 | 1104 | 419 |
| (ng/g) | | | |

TABLE 5
Metal levels of the compositions of Table 4.

| | Metals present |
|---|---|
| Neat | Al, Ca, Co, Fe, K, Na, Ni, Pb, Sn, Ti |
| Carbon fiber (18%) | B, Ca, Co, Fe, K, Mg, Na, Ni, Zn |
| Metal Oxide Ceramic (52%) | Al, B, Ba, Ca, Co, Cr, Cu, Fe, K, Mg, |
| | Mn, Na, Ni, Pb, Sb, Sn, Ti, Zn |

TABLE 6
Anions of the various PEEK compounds of Table 4.

| Anion | | Carbon fiber | Metal oxide |
|---|---|---|---|
| (ng/g) | Neat | (18%) | (52%) |
| Fluoride | 410 | 34 | 56 |
| Chloride | BDL | 400 | 280 |
| Nitrate | BDL | 130 | 14 |
| Sulfate | 10 | For 70 | 60 |
| Phosphate | 44 | BDL | 900 |

BDL indicates below detection limits

The embodiments described herein are provided as examples of the invention and are not intended to limit the scope and spirit of the invention. All patents and publications, including applications, set forth in this application are hereby incorporated herein by reference.

1. An article for receiving electronic components, the article comprising:
a structure for contacting and supporting an electronic component, the structure comprising at least one electrostatic discharge-safe surface that comprises a mixture of at least one high temperature, high strength polymer and at least one metal oxide, wherein the surface has an L value of more than about 40, and wherein the article is a member of the group consisting of a matrix tray and a chip tray.

2. The article of claim 1 wherein the surface comprises a bottom of a pocket.

3. The article of claim 1 wherein the surface has an L value of more than about 55.

4. The article of claim 1 wherein the surface has an L value of more than about 65.

5. The article of claim 1 wherein the polymer has a stiffness of at least about 1 GPa and a glass transition temperature or melting point higher than about 150° C.

6. The article of claim 1 wherein the metal oxide is present at a concentration of about 40% to about 75% by weight.

7. The article of claim 1 wherein the at least one metal oxide comprises a member of the group consisting of aluminum borate, zinc oxide, basic magnesium sulfate, magnesium oxide, graphite, potassium titanate, magnesium borate, titanium diboride, tin oxide, calcium sulfate, and antimony doped tin oxide.

8. The article of claim 1 wherein the high temperature, high strength polymer comprises a member of the group consisting of polyphenylene sulfide, polyetherimide, polyarylketones, polyetherketone, polyetheretherketone, polyetherketoneketone, polyethersulfone.

9. The article of claim 1 wherein the at least one metal oxide is present at a concentration of about 50% to about 60% by weight.

10. The article of claim 1 wherein at least a portion of the surface comprises a bottom of a pocket, with the bottom being flatter than an average of about 0.03 inches per inch.

11. The article of claim 1 wherein at least a portion of the surface comprises a bottom of a pocket, with the bottom being flatter than an average of about 0.015 inches per inch.

12. The article of claim 1 wherein the high temperature, high strength polymer comprises a member of the group consisting of polyphenylene oxide, ionomer resin, nylon 6 resin, nylon 6,6 resin, aromatic polyamide resin, polycarbonate, polyacetal, trimethylpentene resin, polysulfone, tetrafluoroethylene/perfluoroalkoxyethylene copolymer, high-temperature amorphous resin, polyallylsulfone, liquid crystal polymer, polyvinylidene fluoride, ethylene/tetrafluoroethylene copolymer, tetrafluoroethylene/hexafluoropropylene copolymer, and tetrafluoroethylene/hexafluoropropylene/perfluoroalkoxyethylene terpolymer.

13. The article of claim 1 wherein the at least one metal oxide is disposed as a plurality of particles.

14. The article of claim 13 wherein the wherein the particles comprise an isotropic flow shape.

15. The article of claim 1 wherein the pigment comprises a member of the group consisting of titanium dioxide, iron oxide, chromium oxide greens, iron blue, chrome green, aluminum sulfosilicate, cobalt aluminate, barium manganate, lead chromates, cadmium sulfides and selenides.

16. The article of claim 1 wherein the at least one metal oxide is the at least one pigment.

17. The article of claim 1 wherein the surface comprises a resistivity in the range of 10³ to 10¹⁴ ohms per square.

18. A set of colored carriers for electronic component processing, the set comprising:
at least two subsets of colored carriers wherein each colored carrier comprises an electrostatic discharge-safe surface, with each subset comprising a subset color distinct from the other subset colors, wherein the surfaces comprise a high temperature, high strength polymer, a metal oxide, and a pigment, and wherein the carrier is a member of the group consisting of a disk processing cassette, a matrix tray, a chip tray, and a wafer carrier.

19. The set of trays of claim 18 wherein each subset of carriers corresponds to a different model of carrier.

20. The set of trays of claim 18 wherein each subset of carriers corresponds to a type of component in the carriers.

21. The set of claim 18 wherein the pockets are flatter than an average of about 0.03 inches per inch.

22. The set of claim 18 wherein the carriers comprise a plurality of pockets, wherein the pockets are flatter than an average of about 0.015 inches per inch.

23. The set of claim 18 wherein the surface has an L value of at least about 40.

24. The set of claim 18 wherein the at least one metal oxide is chosen from the group consisting of aluminum borate, zinc oxide, basic magnesium sulfate, magnesium oxide, graphite, potassium titanate, magnesium borate, titanium diboride, tin oxide, calcium sulfate, and antimony doped tin oxide.

25. The set of claim 18 wherein the at least one metal oxide is present at a concentration between 50 and 70 percent by weight.

26. The article of claim 18 wherein the surface further comprises a pigment.

27. A method for processing electronic components, the method comprising placing an electronic component on an electrostatic discharge-safe surface of a colored carrier, with the surface comprising a mixture of at least one high temperature, high strength polymer, at least one metal oxide, and at least one pigment, wherein the carrier is a member of the group consisting of a disk processing cassette, a matrix tray, and a chip tray.

28. The method of claim 27 wherein the at least one the high temperature, high strength polymer comprises a member of the group consisting of polyphenylene sulfide, polyetherimide, polyarylketones, polyetherketone, polyetheretherketone, polyetherketoneketone, polyethersulfone.

29. The method of claim 27 wherein the at least one metal oxide is present at a concentration is about 40% to about 75% by weight.

30. The method of claim 27 wherein the surface has a L value of at least about 40.

31. The method of claim 27 wherein at least a portion of the surface is flatter than an average of about 0.03 inches per inch.

32. The method of claim 27 wherein the at least one metal oxides comprises particles are present in the mixture at a concentration of at least about 40 percent by weight.

33. The method of claim 27 wherein at least a portion of the at least one metal oxide comprises a whisker.

34. The method of claim 27 wherein the at least one metal oxide comprises particles that comprise an isotropic flow shape.

35. The method of claim 27 wherein the at least one pigment is the at least one metal oxide.

36. The method of claim 27 wherein the surface comprises a resistivity in the range of 10³ to 10¹⁴ ohms per square.

37. The method of claim 27 wherein the colored tray is a matrix tray.

38. The method of claim 27 wherein the at least one pigment comprises a member of the group consisting of titanium dioxide, iron oxide, chromium oxide greens, iron blue, chrome green, aluminum sulfosilicate, cobalt aluminate, barium manganate, lead chromates, cadmium sulfides and selenides.

39. A method of producing an article for electronic processing, the method comprising:
molding a carrier comprising an electrostatic discharge-safe surface that comprises a high temperature, high strength polymer and a conductive filler, an L value of at least about 40, and a resistivity in the range of 10³ to 10¹⁴ ohms per square, and wherein the carrier is a member of the group consisting of a matrix tray and a chip tray.

40. The method of claim 39 wherein the polymer has a glass transition temperature or melting point higher than about 150° C. and a stiffness of at least about 1 GPa.

41. The method of claim 39 wherein the conductive filler is a metal oxide present in a concentration of about 40% to about 75% by weight.

42. A carrier for receiving electronic components comprising:
a carrier having a structure for contacting and supporting an electronic component, the structure comprising at least one electrostatic discharge-safe surface that comprises a mixture of at least one high temperature, high strength polymer and at least one metal oxide, wherein the surface has an L value of more than about 40, wherein the carrier is a member of the group consisting of a wafer carrier and a disk processing cassette.

43. The article of claim 42 wherein the at least one metal oxide is present at a concentration of about 40% to about 75% by weight.

44. The article of claim 42 wherein the at least one metal oxide is present at a concentration of at least about 50% by weight.

45. The article of claim 42 wherein the at least one metal oxide comprises a member of the group consisting of aluminum borate, zinc oxide, basic magnesium sulfate, magnesium oxide, graphite, potassium titanate, magnesium borate, titanium diboride, tin oxide, calcium sulfate, and antimony doped tin oxide.

46. The article of claim 42 wherein the polymer has a stiffness of at least about 1 GPa and a glass transition temperature or melting point higher than about 150° C.

47. The article of claim 42 further comprising a pigment.

48. The article of claim 47 wherein the pigment is a member of the group consisting of titanium dioxides, iron oxides, and chromium oxide greens.

49. The article of claim 47 wherein the pigment is not an oxide.

50. The article of claim 42 wherein the high temperature, high strength polymer comprises a member of the group consisting of polyphenylene sulfide, polyetherimide, polyarylketones, polyetherketone, polyetheretherketone, polyetherketoneketone, polyethersulfone.

51. The method of claim 42 wherein the at least one metal oxide comprises particles that have an isotropic flow shape.

52. A method of producing an article for electronic processing, the method comprising:
molding a carrier comprising an electrostatic discharge-safe surface that comprises a high temperature, high strength polymer and a conductive filler, an L value of at least about 40, and a resistivity in the range of 10³ to 10¹⁴ ohms per square, and wherein the carrier is a member of the group consisting of a wafer carrier and a disk processing cassette.

53. The method of claim 52 further comprising coloring the carrier with a pigment.

54. The method of claim 52 wherein the conductive filler comprises a metal oxide present at a concentration of about 40% to about 75% by weight.

55. The method of claim 54 wherein the metal oxide comprises particles that have an isotropic flow shape.

56. The method of claim 52 wherein the filler comprises particles that have an isotropic flow shape.
